(19) United States
(12) Patent Application Publication
(10) Pub. No.: US 2012/0297339 A1
(43) Pub. Date: Nov. 22, 2012

(54) ELECTRONIC DEVICE, CONTROL METHOD, AND STORAGE MEDIUM STORING CONTROL PROGRAM

(75) Inventor: Fumiyuki ITO, Yokohama-shi (JP)

(73) Assignee: KYOCERA CORPORATION, Kyoto (JP)

(21) Appl. No.: 13/560,344

(22) Filed: Jul. 27, 2012

(30) Foreign Application Priority Data
Jan. 27, 2011 (JP) 2011-164848

(51) Int. Cl. G06F 3/041; G06F 3/048

(52) U.S. Cl. 715/810

(57) ABSTRACT

According to an aspect, an electronic device includes a display unit, a touch sensor, and a control unit. The display unit displays an image and an icon. The touch sensor detects a contact. When a first operation of coming in contact to the icon and moving in a first direction is detected, the control unit causes the display unit to move the image in the first direction with keeping the icon displaying.

### CROSS-REFERENCE TO RELATED APPLICATIONS

This application claims priority from Japanese Application No. 2011-164848, filed on Jul. 27, 2011, the content of which is incorporated by reference herein in its entirety.

### BACKGROUND

1. Technical Field

The present disclosure relates to an electronic device, a control method, and a storage medium storing a control program.

2. Description of the Related Art

Recently, as a mobile electronic device such as a mobile phone, a mobile electronic device with a touch panel has been proposed. The touch panel functions as both a display unit and an input unit, and is placed on almost the whole surface of a side of the housing. The mobile electronic device provided with such a touch panel has various ways to set a screen to be displayed. For example, Japanese Patent Laid-Open No. 2009-169820 describes a mobile terminal (mobile electronic device) which determines whether it is held by the left hand, by the right hand, or by the both hands, and switches the screen to be displayed according to the way the user holds it.

As described in the above patent literature, adjusting the image to be displayed based on the way the user holds the housing allows the image to be displayed in such a manner that the image is more easily viewed by the user. However, the device described in the above patent literature needs to be provided with a sensor for judging the way the user holds the device. In addition, when the screen display is adjusted according to the way the user holds the device, an image displayed on some types of screen may be distorted and become difficult to be viewed.

Also, the mobile electronic device can scroll the image displayed on the touch panel based on the operation input by the user for the touch panel. In that case, as the scroll operation of the image, it can be considered a sweeping action of bringing a finger or the like in contact with the touch panel and moving the finger or the like in the direction the user wants to move the image while keeping the finger or the like in contact with the touch panel. Here, the sweeping action includes an operation of bringing the finger or the like in contact with the touch panel. Therefore, the finger or the like that input the sweeping action may hide the image newly displayed by scrolling, so that the newly displayed image cannot be viewed as soon as it appears.

For the foregoing reasons; there is a need for an electronic device, a control method, and a control program that allow a user to input a scroll operation of the image displayed on the touch panel while keeping the image on the touch panel viewable to the user.

### SUMMARY

According to an aspect, an electronic device includes a display unit, a touch sensor, and a control unit. The display unit displays an image and an icon. The touch sensor detects a contact. When a first operation of coming in contact to the icon and moving in a first direction is detected, the control unit causes the display unit to move the image in the first direction with keeping the icon displaying.

According to another aspect, a control method is performed for an electronic device including a display unit and a touch sensor. The control method includes: displaying an image and an icon by the display unit; detecting a contact by the touch sensor; determining whether a first operation of coming in contact to the icon and moving in a first direction is performed based on the contact detected by the touch sensor; and moving the image in the first direction with keeping the icon displaying when it is determined that the first operation is performed.

According to another aspect, a non-transitory storage medium stores therein a control program. When executed by an electronic device which includes a display unit and a touch sensor, the control program causes the electronic device to execute; displaying an image and an icon by the display unit; detecting a contact by the touch sensor; determining whether a first operation of coming in contact to the icon and moving in a first direction is performed based on the contact detected by the touch sensor; and moving the image in the-first direction with keeping the icon displaying when it is determined that the first operation is performed.

### BRIEF DESCRIPTION OF THE DRAWINGS

FIG. 1 is a perspective view of a mobile phone;

FIG. 2 is a front elevation view of the mobile phone;

FIG. 3 is a block diagram of the mobile phone;

FIG. 4 is a diagram illustrating an example of control performed according to an operation for a touch sensor;

FIG. 5 is a diagram illustrating an example of control performed according to an operation for the touch sensor;

FIG. 6 is a diagram illustrating an example of control performed according to an operation for the touch sensor;

FIG. 7 is a flow chart describing en operation of the mobile phone;

FIG. 8 is a diagram illustrating another example of control performed according to an operation for the touch sensor;

FIG. 9 is a diagram illustrating an example of control performed according to an operation for the touch sensor;

FIG. 10 is a diagram illustrating an example of control performed according to an operation for the touch sensor;

FIG. 11 is a flow chart describing an operation of the mobile phone;

FIG. 12 is a flow chart describing an operation of the mobile phone; and

FIG. 13 is a diagram illustrating an example of control performed according to an operation for the touch sensor.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the electronic device; however, the present invention is not limited to mobile phones. Therefore, the present invention can be applied to a variety of devices, including but not limited to personal handyphone systems (PHS), personal digital assistants (PDA), portable navigation units, personal computers (including but not limited to tablet computers, netbooks etc.), media players, portable electronic reading devices, and gaming devices.

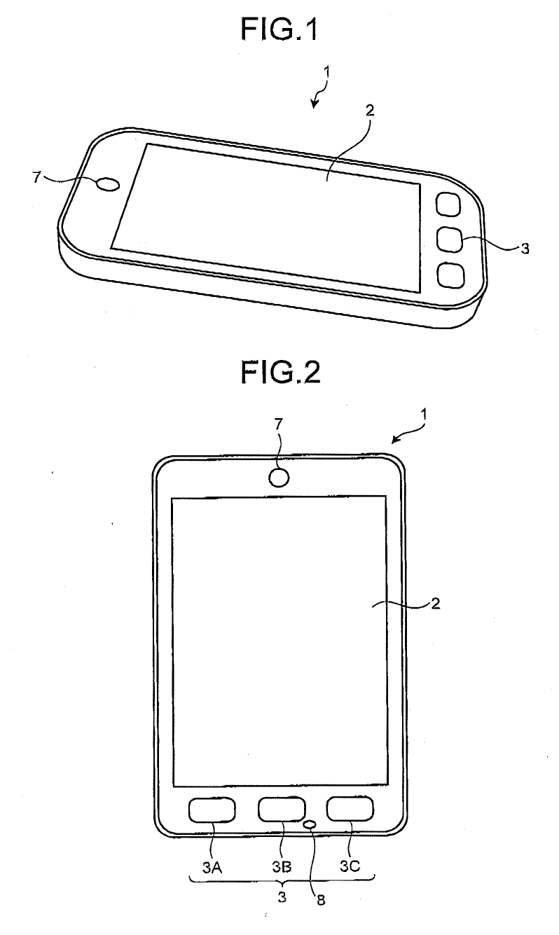

An overall configuration of a mobile phone 1, which is an embodiment of the electronic device, will be described with reference to FIG. 1 and FIG. 2. FIG. 1 is a perspective view of the mobile phone 1. FIG. 2 is a front elevation view of the mobile phone 1. As illustrated in FIG. 1 and FIG. 2, the mobile phone 1 has a housing in an almost hexahedron shape with two faces bigger than the other faces. The mobile phone 1 includes a touch panel 2, an input unit 3, a speaker 7, and a microphone 8 on the surface of the housing.

The touch panel 2 is provided on one of the biggest faces (the front face, the first face), and displays characters, graphics, images and the like. The touch panel 2 detects contact(s), whereby the mobile phone 1 determines various operations (gestures) performed for the touch panel 2 with a finger, a stylus, a pen and the like (in the description herein below, for the sake of simplicity, it is assumed that the user touches the touch panel with his/her fingers). Any detection methods, including but not limited to, a pressure sensitive type detection method and a capacitive type detection method, may be adopted as the detection method of the touch panel 2. The input unit 3 includes a plurality of buttons such as a button 3A, a button 3B, and a button 3C to which certain functions are allocated. The speaker 7 outputs a voice of the other person on the phone, music and sound effects reproduced by respective programs, and the like. The microphone 8 obtains sounds during phone call or in receiving a voice operation.

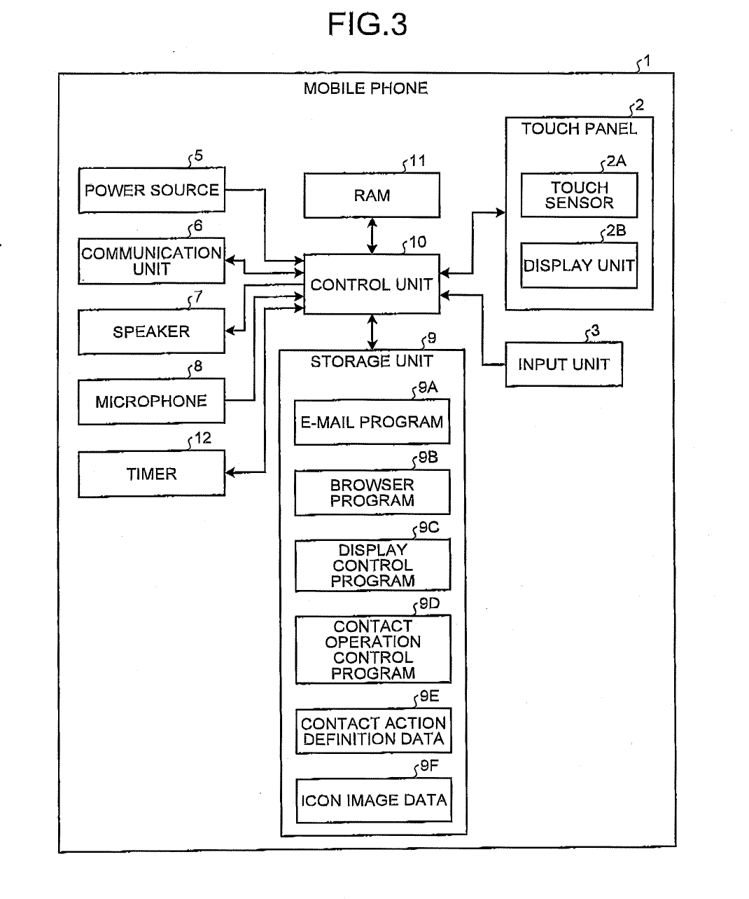

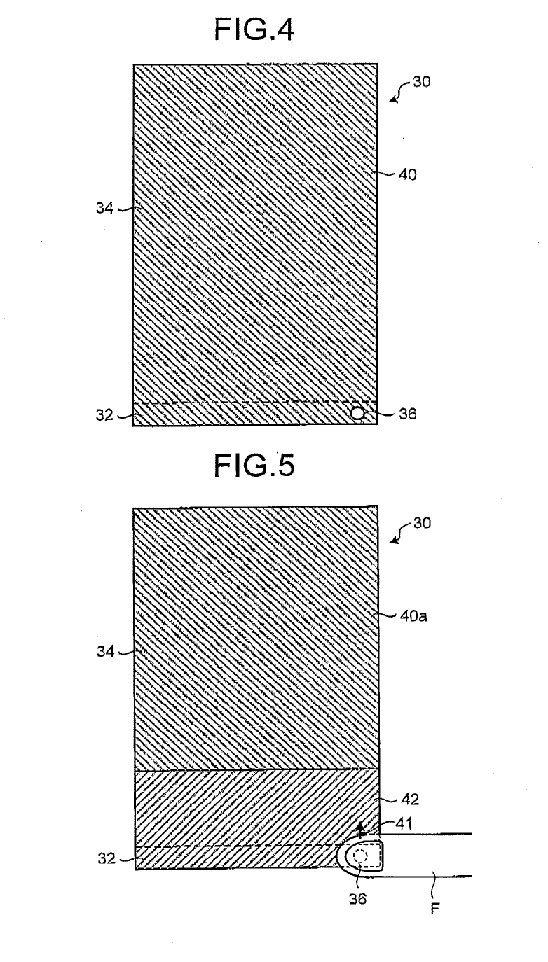

A functional configuration of the mobile phone 1 will be described with reference to FIG. 3. FIG. 3 is a block diagram of the mobile phone 1. As illustrated in FIG. 3, the mobile phone 1 includes the touch panel 2, the input unit 3, a power source 5, a communication unit 6, the speaker 7, the microphone 8, a storage unit 9, a control unit 10, a RAM (Random Access Memory) 11, and a timer 12.

The touch panel 2 includes a display unit 2D, and a touch sensor (contact detection unit) 2A superimposed on the display unit 2B. The touch sensor 2A detects contact(s) with the touch panel 2 performed by using finger(s) well as the position(s) on the touch panel 2 to which the finger(s) are brought, and informs the control unit 10 of them. Thereby, the control unit 10 determines an operation (gesture) performed for the touch sensor 2A. Examples of the operation for the touch sensor 2A include, but are not limited to, a tap operation and a sweep operation. In the following explanation, for the sake of simplicity of explanation, the fact that the touch sensor detects the contact(s) and then the control unit determines the type of the operation (gesture) as X based on the contact(s) may be simply described as “the mobile phone detects X”, “the control unit detects X”, “the touch panel detects X”, or “the touch sensor detects X”. The display unit 2B is made of, for example, a LCD (Liquid Crystal Display) or an OELD (Organic Electro-Luminescence Display), and displays characters, graphics, and the like.

The input unit 3 receives a user's operation through the physical button or the like, and sends a signal corresponding to the received operation to the control unit 10. The power source 5 supplies the electric power obtained from a battery or an external source to the respective functional parts of the mobile phone 1 including the control unit 10.

The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a sound signal sent from the control unit 10 as the sound. The microphone 8 converts the voice of the user and the like into a sound signal and sends it to the control unit 10.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. The programs stored in the storage unit 9 include an e-mail program 9A, a browser program 9B, a display control program 9C, and a contact operation control program 9D. The data stored in the storage unit 9 includes contact action definition data 9E and icon image data 9F. The storage unit 9 also stores the other programs and data such as an operating system program for implementing basic functions of the mobile phone 1, address book data and the like. The storage unit 9 may be configured as a combination of a portable storage medium such as a memory card and a reader of the storage medium.

The e-mail program 9A provides capabilities for implementing an e-mail function. The browser program 9B provides capabilities for implementing a WEB browsing function. The display control program 9C controls to display characters, graphics and the like on the touch panel 2 in cooperation with the capabilities provided by another program. The contact operation control program 9D provides capabilities for implementing processing according to respective contact operations for the touch sensor 2A. The contact action definition data 9E maintains a definition of a function to be activated according to the result detected through the touch sensor 2A. The icon image data 9F maintains images of respective icons to be displayed on the display unit 2B. The icon image data 9F of the embodiment maintains an image modeled after a three-dimensional trackball (for example, a rotatable sphere) as one of icon images.

The control unit 10 is a CPU (Central Processing Unit), for example, and controls integrally operations of the mobile phone 1 to implement respective functions. Specifically, the control unit 10 controls the display unit 2B, the communication unit 6 and the like to implement the respective functions by executing commands included in the program stored in the storage unit 9 with reference to data stored in the storage unit 9 or data loaded to the RAM 11. The program and data which are executed and referenced by the control unit 10 may be downloaded from a server via communication by the communication unit 6.

The control unit 10 implements the e-mail function by executing the e-mail program 9A, for example. The control unit 10 implements capabilities for performing corresponding processing according to respective contact operations for the touch sensor 2A, by executing the contact operation control program 9D. The control unit 10 implements capabilities for controlling to display the image and the like to be used for respective functions on the touch panel 2 by executing the display control program 9C. It is assumed that the control unit 10 is capable of executing a plurality of programs in parallel by using a multitask function provided by the operating system program.

The RAM 11 is used as a storage area which temporarily stores commands of the program to be executed by the control unit 10, data to be referenced by the control unit 10, and results of the operation or the like by the control unit 10.

The timer 12 is a processing unit for measuring elapsed time. Although the mobile phone 1 of the embodiment exemplifies a configuration having a timer for measuring elapsed time independently of the control unit 10, a timer function may be provided for the control unit 10.

Operations of the mobile phone 1, specifically examples of control performed by the control unit 10 according to an operation for the touch sensor 2A, will be described with reference to FIG. 4 to FIG. 6. FIG. 4 to FIG. 6 are diagrams illustrating examples of control performed according to operations for the touch sensor, respectively. FIG. 4 to FIG., 6 illustrate only the touch panel 2 part of the mobile phone 1, omitting the housing part around the touch panel 2. The examples illustrated in FIG. 4 to FIG. 6 are examples of images displayed when an application program, such as a browser or the like, that is configured to display an image bigger than the touch panel 2 on the touch panel 2 is executed.

The mobile phone 1 sets the display area 30 on the touch panel 2. The display area 30 includes a bottom area 32 which is a lower part of the display area 30 in the up-down direction, and a main area 34 which is ₐn area other than the bottom area 32. The bottom area 32 is extended in the left-right direction through ₜhe display area 30 at the end portion of the lower part of the display area 30 in ₜhe up-down direction. The border line between ₜhe bottom area 32 and the main area 34 is a line parallel to the left-right direction (transverse direction) of the display area 30. The touch panel 2 displays an icon 36 and an image 40 in the display area 30. The icon 36, which is an image modeled after a trackball, is placed in the bottom area 32. The icon 36 of the embodiment is placed at the right side of the display area in the bottom area 32.

The image 40, which is, for example, an image of a Web page obtained by executing the browser program 9B, is displayed in the whole area of the display area 30. That is, the image 40 is a single image displayed in both the main area 34 and the bottom area 32. The display area 30 has the icon 36 superimposed on the image 40. That is, the image of the icon 36 is displayed at the position where the icon 36 and the image 40 overlap.

It is supposed that the mobile phone 1 detects that a finger F comes in contact to the icon 36 as illustrated in FIG. 5, i.e., detects the contact of the finger F with an area of the touch panel 2 where the icon 36 is displayed, while the icon 36 is displayed as illustrated in FIG. 4. The mobile phone 1 then detects an operation of sliding the finger F toward the upside of the display area 30 while the finger F is in contact with the touch panel 2, i.e., an operation of flicking the icon 36 toward the upside of the display area 30 (in the direction of arrow 41) through the touch sensor 2A of the touch panel 2. In this case, the mobile phone 1 moves (slides) the image displayed in the display area 30 upward in the area as illustrated in FIG. 5. The display area 30 contains a partial image 40a that is the lower part of the image 40 and an image 42 associated with the lower part of the image 40. That is, the mobile phone 1 moves the image to be displayed, based on the flick operation for the icon 36. The flick operation is an operation of flicking the contact area in a certain direction, which is an action of flicking the icon 36 toward the upside of the display area 30 in FIG. 5, and the finger F after inputting the flick operation can be kept near the icon 36. When the mobile phone 1 detects an operation of flicking the icon 36 in the up-down direction, the mobile phone 1 moves the image 40 based on the operation without changing the display position of the icon 36.

It may be configured that the mobile phone 1 displays the image of the icon 36 (trackball) as if the icon 36 turns at the place (in the displayed area) in association with the direction of the flick operation input for the icon 36. Thus turning the icon 36 clarifies the association between the input operation and the displayed operation; therefore an intuitive operation is achieved.

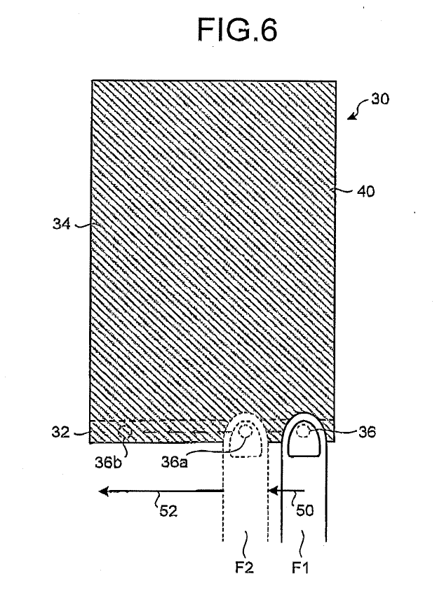

It is supposed that the mobile phone 1 detects that a finger F1 comes in contact to the icon 36 as illustrated in FIG. 6 while the icon 36 is displayed as illustrated in FIG. 4. The mobile phone 1 then detects a slide operation of sliding the finger F1 leftward in the display area 30 while the finger F1 is in contact with the touch panel 2. In this case, the mobile phone 1 changes the position of the icon 36 in the left-right direction in the display area 30 in the bottom area 32. Specifically, when the user inputs a slide operation of moving the finger F1 position to the finger F2 position (the slide operation of coming in contact to the icon 36 and subsequently moving the contact point in the direction indicated by arrow 50) for the touch panel 2 as illustrated in FIG. 6 and the mobile phone 1 detects the slide operation through the touch panel 2, the mobile phone 1 sets the display position of the icon 36 to the destination of the slide operation, i.e., the position where the finger F2 is in contact, and displays the icon 36 there. Alternatively, when detecting a slide operation of coming in contact to the icon 36a and moving the contact point in the direction indicated by arrow 52 while the icon 36a is displayed, the mobile phone 1 sets the display position of the icon 36 to the destination of the slide operation and displays the icon 36b there. When moving the icon 36 in the left-right direction, the mobile phone 1 may move the display position of the icon while representing an image of turning trackball, which constitutes the icon. Thus, intuitive recognition of the left-right movement of the icon 36 is facilitated.

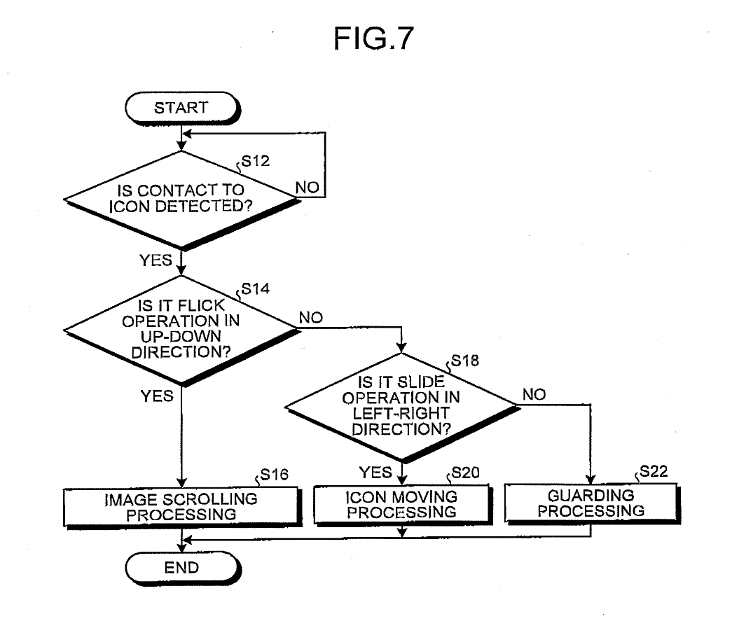

An operation of the mobile phone 1 in detecting a contact operation will be described with reference to FIG. 7. FIG. 7 is a flow chart describing an operation of the mobile phone. The procedure described in FIG. 7 is repeated based on the function provided by the contact operation control program 9D. The control unit 10 also performs processing corresponding to detection of another contact operation in parallel with the procedure based on the function provided by the contact operation control program 9D.

At Step S12, the control unit 10 of the mobile phone 1 determines whether a contact to the icon is detected, i.e., whether the touch sensor 2A of the touch panel 2 detects a contact operation for the area displaying the icon 36. When determining that a contact to the icon is not detected (No), the control unit 10 proceeds to Step S12. That is, the control unit 10 repeats the processing of Step S12 until a contact to the icon is detected.

When determining that a contact to the icon is detected (Yes) at Step S12, the control unit 10 determines whether it is a flick operation in the up-down direction, i.e., whether the input operation is an operation of flicking the icon 36 upward or downward, at Step S14. When determining that it is a flick operation in the up-down direction (Yes) at Step S14, the control unit 10 performs image scrolling processing at Step S16, and ends the procedure. That is, the control unit 10 performs processing of moving the image based on the direction of the detected flick operation as illustrated in FIG. 5, and ends the procedure.

When determining that it is not a flick operation in the up-down direction (No) at Step S14, the control unit 10 determines whether it is a slide operation in the left-right direction, at Step S18. When determining that it is a slide operation in the left-right direction (Yes), the control unit 10 performs icon moving processing at Step S20, and ends the procedure. That is, the control unit 10 performs processing of moving the display position of the icon based on the direction of the detected slide operation as illustrated in FIG. 6, and ends the procedure.

When determining that it is not a slide operation in the left-right direction (No) at Step S18, the control unit 10 performs guarding processing at Step S22, and ends the procedure. The guarding processing is processing for cancelling the input operation.

In the embodiment, the control unit 10 moves the image in the up-down direction when detecting a flick operation in the up-down direction at Step 314; however, the direction of the flick operation and the direction of moving the image are not limited thereto. For example, when detecting a flick operation in the left-right direction, the control unit 10 may move the image in the left-right direction. When detecting a flick operation in the diagonal direction, the control unit 10 may move the image in the diagonal direction. The direction of moving the image may be the same as the direction of the flick operation for more intuitive operation as described above; however, the present invention is not limited thereto. For example, when detecting a flick operation in the left-right direction or in the diagonal direction, the control unit may move the image in the up-down direction.

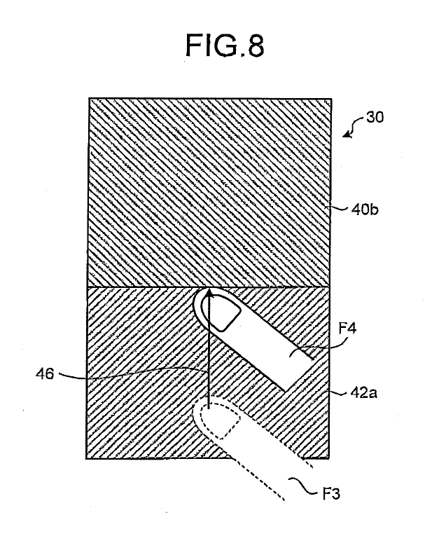

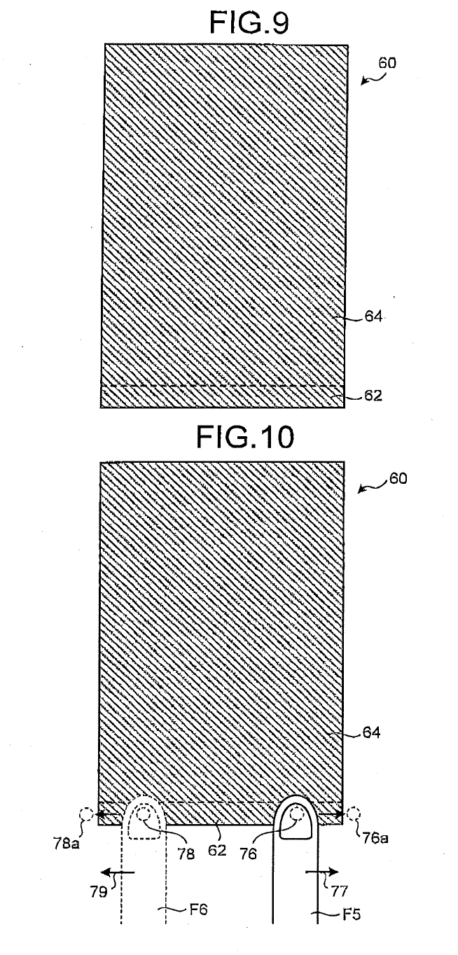

FIG. 8 is a diagram illustrating another example of control performed according to an operation for the touch sensor. A mobile phone may be configured to detect an operation of coming in contact to an area where an objective image is displayed with a finger F3 and then moving the finger F3 in the direction indicated by arrow 46 to the position indicated by a finger F4 as illustrated in FIG. 8, for example, as an operation of scrolling the image in the display area 30. In this case, by detecting the slide operation by the finger illustrated in FIG. 8, the mobile phone can transfer a display state from a state where only the image 40 is displayed as illustrated in FIG. 4 to a state where an image including an image 40b and an image 42a is displayed. The image 40b is a partial image 40b of the lower part of the image 40, and the image 42a is associated with the lower part of the image 40. However, when the slide operation to the image 40 to be slid is an operation of moving the image, a newly displayed image 42a is partially hidden by the finger F4 as illustrated in FIG. 8.

On the other hand, the mobile phone 1 of the embodiment displays the icon in the bottom area 32 of the display area 30, and when detecting a flick operation in the up-down direction input for the icon, the mobile phone 1 scrolls the image displayed in the display area 30 based on the flick operation. That is, when a flick operation is input for the icon displayed at the bottom of the display area 30, the mobile phone 1 slides the image. Therefore, the image can be scrolled only by moving a finger at the bottom of the display area, which can keep the image on the touch panel viewable while allowing the scroll operation on the image displayed on the touch panel. Also, the mobile phone 1 can largely scroll the image in response to a plurality, of flick operations on the icon at the bottom of the display area. That allows the scroll operation to be performed easily even when the finger has a small range of motion such as when the operation is input by a hand which holds the mobile phone 1.

The mobile phone 1 can apply various rules to the movement in moving the image based on the input flick operation. For example, the mobile phone 1 may decide the movement of the image based on the input speed of the contact point at which the flick operation is input (i.e., the moving speed of the finger). Alternatively, the mobile phone 1 may set a condition such as resistance of a real trackball to the icon, detect the rotation of the trackball based on the input flick operation, and make the rotation as the movement of the icon. That is, the mobile phone 1 may decide the movement of the image also by taking account of the rotation of the trackball according to inertia based on the input flick operation. Alternatively, the mobile phone 1 may assume the icon to be a trackball without resistance, and when a flick operation is input, it may decide the moving speed of the image based on the input speed of the contact point at which the flick operation is input, and move the image at the moving speed until it detects an operation to stop the rotation of the icon (for example, an operation of coming in contact to the icon). By assuming the icon to be a trackball and deciding the movement of the image based on the movement of the trackball which is decided by the flick operation input for the icon as described above, the mobile phone 1 allows the user to adjust the movement of the image as required, and thus, can further improve the operability.

When detecting a slide operation in the left-right direction for the icon, the mobile phone 1 can arrange the icon at a position convenient for the operation by moving the position of the icon in the left-right direction. The mobile phone 1 enables easy operation with one hand by arranging the icon at the right side of the display area as the above described embodiment when the mobile phone 1 is operated by the right hand and by arranging the icon at the left side of the display area when the mobile phone 1 is operated by the left hand, for example. The position of the icon may also be arranged at the position decided by setting. That is, the move operation of the icon may be performed in another mode so as not to be performed during the detection of the move operation of the image,

When detecting a slide operation in the left-right direction for the icon, the mobile phone 1 according to the above described embodiment moves the position of the icon in the left-right direction; however, the present invention is not limited thereto. When detecting a slide operation in the left-right direction on the icon, the mobile phone 1 may move the image displayed in the display area in the left-right direction. Alternatively, when detecting a slide operation in the left-right direction for the icon, the mobile phone 1 may move the position of the icon in the left-right direction, and when detecting a flick operation in the left-right direction for the icon, the mobile phone 1 may move the image displayed in the display area in the left-right direction. By sliding the image in the left-right direction in response to detection of an operation in the left-right direction for the icon as described above, the mobile phone can move the image in the left-right direction by receiving only the input of the operation for the icon displayed at the bottom of the display area.

The mobile phone 1 may be configured to be switched between the mode of displaying an icon and scrolling the image correspondingly to a flick operation input for the icon (hereinafter, referred to as “one hand mode”) and the mode of not displaying an icon and scrolling the image in response to receiving input of a slide operation performed by a finger or the like for the displayed image as illustrated in FIG. B (hereinafter, referred to as “normal mode”).

FIG. 9 and PIG. 10 are diagrams illustrating examples of control performed by the control unit according to operations for the touch sensor, respectively. In the normal mode, the mobile phone 1 does not display an icon in a display area 60 as illustrated in FIG. 9. The display area 60 includes a bottom area 62 which is a lower part of the display area 60 in the up-down direction, and a main area 64 which is an area other than the bottom area 62. When the bottom area 62 is long touched, i.e., when an operation of keeping a contact state continuously for a predetermined time period or more is input to the bottom area 62 while the mobile phone 1 is processing in the normal mode as described above, the mobile phone 1 may shift from the normal mode to the one hand mode.

In the one hand mode, the mobile phone 1 displays an icon 76 in the bottom area 62 at the lower part of the display area 60 bellow the main area 64 as illustrated in FIG. 10. When detecting input of an operation of coming in contact to the icon 76 with a finger F5 and then moving the finger F5 in the direction of arrow 77 (the left-right direction) to move the icon 76 to the position of an icon 76a while displaying the icon 76 in the one hand mode, the mobile phone 1 may shift to the normal mode. The operation of moving the icon 76 to the position of the icon 76a is an operation of moving the finger F5 to the right end of the bottom area 62 and then moving the finger F5 to the outside of the display area 60. Since the icon 76 is outside the display area 60, the operation of moving the icon 76 to the position of the icon 76a is an operation to be partly complemented hypothetically.

The operation of moving the icon to the outside of the lower area is not limited to moving it to the right end and may be moving it to the left side. When detecting input of an operation of coming in contact to an icon 78 with a finger F6 and then moving the finger F6 in the direction of arrow 79 (the left-right direction) to move the icon 78 to the position of an icon 78a while displaying the icon 78 in the one hand mode, the mobile phone 1 may shift to the normal mode. The operation of moving the icon 78 to the position of the icon 78a is an operation of moving the finger. F6 to the left end of the bottom area 62 and then moving the finger F6 to the outside of the display area 60.

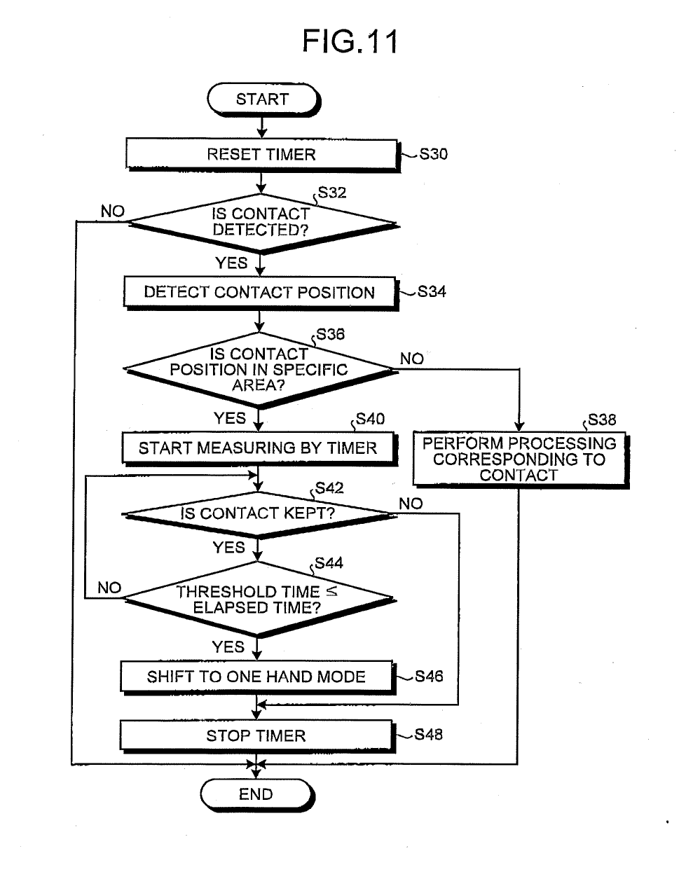

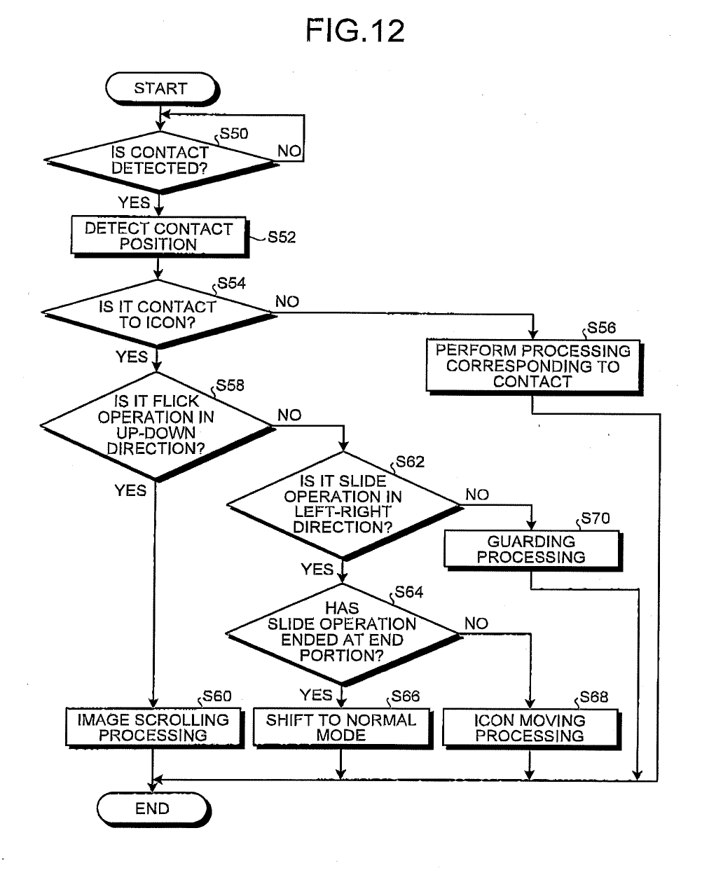

Operations of the mobile phone 1 in detecting a contact operation will be described with reference to FIG. 11 and FIG. 12. FIG. 11 and FIG. 12 are flow charts describing operations of the mobile phone, respectively. The procedures described in FIG. 11,and FIG. 12 are repeated based on the function provided by the contact operation control program 9D. The control unit 10 also performs processing corresponding to detection of another contact operation in parallel with the procedure based on the function provided by the contact operation control program 9D. The processing described in FIG. 11 is the processing performed in the normal mode, and the processing described in FIG. 12 is the processing performed in the one hand mode.

Upon controlling to display an image on the touch panel 2 in the normal mode, the control unit 10 of the mobile phone 1 resets a timer at Step S30 as described in FIG. 11. That is, the control unit 10 resets the time being measured by the timer 12 to 0.

After resetting the timer at Step S30, the control unit 10 determines whether a contact is detected, i.e., whether the touch sensor 2A detects a contact at Step S32. When determining that a contact is not detected (No) at Step S32, the control unit 10 ends the procedure.

When determining that a contact is detected (Yes) at Step S32, the control unit 10 detects the contact position at Step S34, and determines whether the contact position is in a specific area (the bottom area 32 in the embodiment) at Step S36. When determining that the contact position is not in the specific area (No) at Step S36, the control unit 10 performs the processing corresponding to the contact at Step S38. That is, the control unit 10 performs the processing corresponding to the detected operation.

When determining that the contact position is in the specific area (Yes) at Step S36, the control unit 10 starts measuring by the timer at Step S40. That is, the control unit 10 starts measuring the time elapsed after detecting the contact.

After starting the measuring at Step S40, the control unit 10 determines whether the contact is kept at Step S42. When the contact is still detected and also the contact position is in the specific area, the control unit 10 determines that the contact is kept. The control unit 10 may determine that the contact is not kept in the case where the contact position is changed by a certain distance or more.

When determining that the contact is not kept (No) at Step S42, the control unit 10 proceeds to Step S48. When determining that contact is kept (Yes) at Step S42, the control unit 10 determines whether the threshold time 5 the elapsed time, i.e., whether the elapsed time measured by the timer after the start of the contact is longer than the threshold time at Step S44. When the control unit 10 determines that the threshold time 5 the elapsed time is not true (No) at Step S44, i.e., that the threshold time > the elapsed time, the control unit 10 proceeds to Step S42. As such, the control unit 10 repeats the processing of Steps S42 and S44 as long as the contact is kept until the threshold time is elapsed.

When determining that the threshold time the elapsed time is true (Yes) at Step S44, the control unit 10 shifts to the one hand mode at Step S46. That is, the control unit 10 shifts to the mode, in which the control unit 10 displays the icon in the bottom area and allows the scrolling of the image upon detecting a flick operation for the icon.

When determining No at Step S42, or when performing the processing of Step S46, the control unit 10 stops the timer, i.e., the control unit 10 stops measuring the elapsed time by the timer 12 at Step S48, and ends the procedure.

When controlling to display the image on the touch panel 2 in the one hand mode, the control unit 10 of the mobile phone 1 determines whether a contact is detected, i.e., whether the touch sensor 2A detects a contact at Step S50 as described in FIG. 12. When determining that a contact is not detected (No) at Step S50, the control unit 10 proceeds to Step S50. That is, the control unit 10 repeats the processing of Step S50 until the touch sensor 2A detects a contact.

When determining that a contact is detected (Yes) at Step S50, the control unit 10 detects the contact position at Step S52, and determines whether the it is a contact to the icon, i.e., whether the contact position is on the icon at Step S54. When determining that it is not a contact to the icon (No) at Step S54, the control unit 10 performs the processing corresponding to the contact at Step S56. That is, the control unit 10 performs the processing corresponding to the detected operation.

When determining that the it is a contact to the icon (Yes) at Step S54, the control unit 10 determines whether it is a flick operation in the up-down direction, i.e., whether the input operation is an operation of flicking the icon 36 upward or downward at Step S58. When determining that it is a flick operation in the up-down direction (Yes) at Step S58, the control unit 10 performs image scrolling processing at Step S60, and ends the procedure.

When determining that it is not a flick operation in the up-down direction (No) at Step S58, the control unit 10 determines whether it is a slide operation in the left-right direction at Step S62. When determining that it is a slide operation in the left-right direction (Yes), the control unit 10 determines whether the slide operation has ended at the end portion, i.e., whether it is an operation of moving the icon to the end of the display area at Step S64. When determining that the slide operation has ended at the end portion (Yes) at Step S64, the control unit 10 shifts to the normal mode at Step 366, and ends the procedure. That is, the control unit 10 ends displaying of the icon, and ends the procedure to shift to the mode of moving an image by a slide operation with a finger.

When determining that the slide operation has not ended at the end portion (No) at Step S64, the control unit 10 performs icon moving processing at Step S68, and ends the procedure.

When determining that it is not a slide operation in the left-right direction (No) at Step S62, the control unit 10 performs the guarding processing at Step S70, and ends the procedure.

The mobile phone 1 is thus configured to be switched between the normal mode and the one hand mode; therefore, the mobile phone 1 can slide the image in response to an operation suitable for the user's purpose.

The mobile phone 1 can switch the mode in response to simple operations of a long touch to shift from the normal mode to the one hand mode and of moving the icon to the outside of the display area to shift from the one hand mode to the normal mode; however, the mode switch operation is not limited thereto, and various operations can be used. For example, after the mobile phone 1 enters the power saving mode of turning off the lights of the display unit 2B, and then, an operation is input to display an image on the touch panel, the mobile phone 1 may always enter the normal mode or always enter the one hand mode. Alternatively, the mobile phone 1 may also be configured to allow the user to select the menu to select and change the normal mode and the one hand mode.

The mobile phone 1 may analyze an image (Web page) to be displayed, and according to the area size of the image, switch between the one hand mode and the normal mode. That is, the mobile phone 1 may enter the one hand mode when the image is as big as or bigger than a certain area, and enter the normal mode when the image is smaller than a certain area. The mobile phone 1 may be configured to analyze an image (Web page) to be displayed, and only when the image is as big as or bigger than a certain area, to be allowed to shift to the one hand mode. By controlling the switch of the mode according to the area size of the image to be displayed, the mobile phone 1 can provide viewing of the image and moving of the image in more suitable mode.

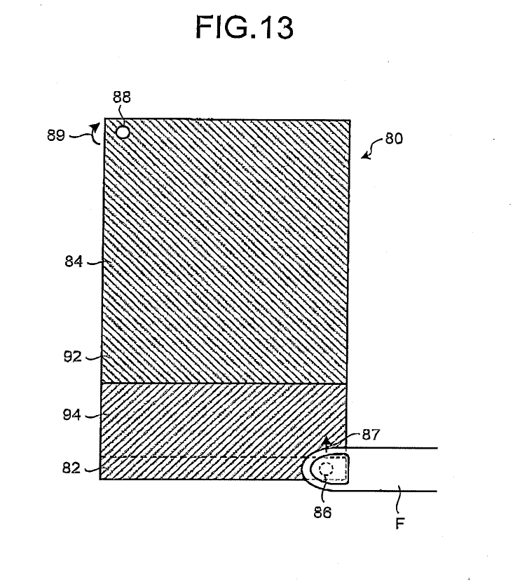

FIG. 13 is a diagram illustrating an example of control performed according to an operation for the touch sensor. The mobile phone 1 may set the display area 80 on the touch panel 2 as illustrated in FIG. 13. The display area 80 includes a bottom area 82 which is a lower part of the display area 80 in the up-down direction, and a main area 84 which is an area other than the bottom area 82. The bottom area 82 is extended in the left-right direction through the display area 80 at the end of the lower part of the display area 80 in the up-down direction. The border line between the bottom area 82 and the main area 84 is a line parallel to the left-right direction (transverse direction) of the display area 80. The touch panel 2 displays an icon 86, an icon image 88, an image 92, and an image 94 on the display area 80.

The icon 86, which is an image modeled after a trackball, is placed in the bottom area 82. The icon 86 of the embodiment is placed at the right side of the display area 80 in the bottom area 82. The icon image 88, which is the same image as the icon 86, is placed in the main area 84. The icon image 88 of the embodiment is placed at the upper left of the display area BO in the main area 84.

The image 92 and the image 94 are for example, images of Web pages obtained by executing the browser program 9B, and the combined image of the image 92 and the image 94 is displayed in the whole area. The image 92 is an image displayed at the upside of the image 94. The image 94 is an image displayed when an image is moved in response to input of a flick operation by the finger F for the icon 86 in the direction of arrow 87. The display area 80 has the icon 86 superimposed on the image 94 and the icon 88 superimposed on the image 92. That is, the image of the icon 86 is displayed at the position where the icon 86 and the image 94 overlap, and the image of the icon image 88 is displayed at the position where the icon image BB and the image 92 overlap.

The mobile phone 1 places the icon image 88, which is the same image as the icon 86, in the main area 84 of the display area 80. The icon image 88 is different from the icon 86 in that it does not cause the image to be moved even when a flick operation is input in the area where the icon image 88 is displayed. When detecting a flick operation input for the icon 86, the mobile phone 1 displays the icon 86 in a turning state and displays the icon image 88 also in a turning state. Specifically, when detecting a flick operation input for the icon 86 in the direction indicated by arrow 87 (upward in the display area) as illustrated in FIG. 13, the mobile phone 1 displays the icon image 88 also as an image turning in the direction indicated by arrow 89 (upward in the display area).

By placing the icon image 88 associated with the icon 86 in the main area 84 as illustrated in FIG. 13, the mobile phone 1 can plainly inform the user what it detected as the operation input for the icon 86. That is, since the icon 86 is hidden by the finger F when the user inputs a flick operation for the icon 86, the user cannot confirm the turning state of the icon 86, though, with the icon image 88 displayed, the user can surely confirm the state of the icon 86.

The mobile phone 1 only needs to use the icon image 88 in so as to represent a state corresponding to the operation input for the icon B6, and may only display the icon image 88 in a turning state without turning the icon 86.

In the above described embodiment, a flick operation for the icon is assumed as the move operation of an image because that enables more intuitive operation; however, the present invention is not limited thereto. As the move operation of an image, various operations to be input for an icon can be used. The above described embodiment is described as the case where the longer direction is the up-down direction of the display area; however, the present invention is not limited thereto. Also in the case where the shorter direction is the up-down direction of the display area, the above described advantage can be provided by displaying the icon in the lower area at the bottom of the display area and performing the above described control.

The advantages are that one embodiment of the invention provides an electronic device, a control method, and a control program that allow a user to input a scroll operation of the image displayed on the touch panel while keeping the image on the touch panel viewable to the user.

What is claimed is:

1. An electronic device comprising:
a display unit for displaying an image and an icon;
a touch sensor for detecting a contact; and
a control unit for causing, when a first operation of coming in contact to the icon and moving in a first direction is detected, the display unit to move the image in the first direction with keeping the icon displaying.

2. The electronic device according to claim 1 wherein
the control unit is configured to cause the display unit to move the image in the first direction without changing a display position of the icon when the first operation is detected.

3. The electronic device according to claim 1 wherein
the icon is modeled after a sphere, and
the control unit is configured to cause the display unit to display the icon as if the sphere is turning when detecting the first operation.

4. The electronic device according to claim 1 wherein
the control unit is configured to decide an amount of the movement of the image based on a moving speed of the first operation.

5. The electronic device according to claim 1 wherein
the control unit is configured to cause, when a second operation of coming in contact to the icon and moving in a second direction is detected, the display unit to move the icon to a position where the second operation is ended.

6. The electronic device according to claim 5 wherein
the icon is modeled after a sphere, and
the control unit is configured to cause the display unit to move the icon to the position while displaying the icon as if the sphere is turning.

7. The electronic device according to claim 1 wherein
the control unit is configured to cause the display unit to end displaying the icon when an operation of coming in contact to the icon and moving to an outside of a display area is detected.

8. The electronic device according to claim 7 wherein
the control unit is configured to cause the display unit to display the icon when an operation of coming in contact and keeping the contact for a threshold time is detected.

9. The electronic device according to claim 1 wherein
the control unit is configured to cause, when an operation of coming in contact to the icon and moving is detected, the display unit to move the image according to the operation.

10. The electronic device according to claim 1 wherein
the control unit is configured to cause the display unit to display an image which is the same image as the icon.

11. A control method for an electronic device including a display unit and a touch sensor, the control method comprising:
displaying an image and an icon by the display unit;
detecting a contact by the touch sensor;
determining whether a first operation of coming in contact to the icon and moving in a first direction is performed based on the contact detected by the touch sensor; and
moving the image in the first direction with keeping the icon displaying when it is determined that the first operation is performed.

12. A non-transitory storage medium that stores a control program for causing, when executed by an electronic device which includes a display unit and a touch sensor, the electronic device to execute:
displaying an image and an icon by the display unit;
detecting a contact by the touch sensor;
determining whether a first operation of coming in contact to the icon and moving in a first direction is performed based on the contact detected by the touch sensor; and
moving the image in the first direction with keeping the icon displaying when it is determined that the first operation is performed.
